(19) United States
(12) Patent Application Publication
(10) Pub. No.: US 2024/0020734 A1
(43) Pub. Date: Jan. 18, 2024

(54) SYSTEMS AND METHODS FOR SELECTIVELY IMPLEMENTING AN ELECTRONIC TRANSACTION BASED ON PROXIMITY DETECTION OF A USER DEVICE

(71) Applicant: SMYLEE PTY LTD, Engadine (AU)

(72) Inventors: Skye Butler, South Coogee (AU); Samuel Gribble, Brighton East (AU); Rajesh Krishnan, Elwood (AU)

(73) Assignee: SMYLEE PTY LTD, Engadine (AU)

(21) Appl. No.: 18/250,355

(22) PCT Filed: Oct. 22, 2021
(86) PCT No.: PCT/AU2021/051231

§ 371 Date: Apr. 24, 2023

(30) Foreign Application Priority Data
Oct. 26, 2020 (AU) 2020903863
Oct. 1, 2021 (AU) 2021903162

(51) Int. Cl. G06Q 30/0279; G06Q 20/32; G06Q 30/08

(52) U.S. Cl. CPC G06Q 30/0279; G06Q 20/327; G06Q 20/3224; G06Q 30/08

(57) ABSTRACT

A system is provided for selectively implementing an electronic transaction based on proximity detection of a user device. The electronic transaction includes primary parameters in the form of the user device being within a distance of a location by a predefined time, and secondary parameters in the form of a bid amount and a bid recipient. The system includes a central server and the user device having a UI configured to receive secondary parameters and being in communication with the central server. The user device further includes a location module for selective location tracking of the user device by the central server. Primary and secondary parameters are transmitted to the central server and the central server conditionally pre-authorizes the electronic transaction such that if the primary parameters are not met, the electronic transaction is implemented based on the secondary parameters.

### CROSS REFERENCE TO RELATED APPLICATIONS

The present application is a § 371 national stage of International Application PCT/AU2021/051231, filed Oct. 22, 2021, which claims priority benefit of Australian Pat. Application AU 2021903162, filed Oct. 1, 2021, and Australian Pat. Application AU 2020903863, filed Oct. 26, 2020, all of which are hereby incorporated herein by reference in their entireties.

### FIELD OF THE INVENTION

The present disclosure relates to systems and methods for selectively implementing an electronic transaction based on proximity detection of a user device.

### BACKGROUND OF THE INVENTION

The present disclosure has applications in the field of location and time-based meeting organisation, high accuracy location tracking, and most particularly relating to accountability of a party being present and punctual at a prearranged meeting. While some embodiments will be described herein with particular reference to that application, it will be appreciated that the invention is not limited to such a field of use and is applicable in broader contexts.

Any discussion of the background art throughout the specification should in no way be considered as an admission that such art is widely known or forms part of common general knowledge in the field.

Event and meeting organization services have been widely used for many years. With the emergence of smartphone technology, such services have been offered in the form of software platforms where users can set up events and invite attendees. Amongst the known platforms, the most widely used particularly in the last couple of years are Facebook's Event and Messenger platforms, as well as the WhatsApp messaging service. Other meeting organizers include Eventbrite, Instagram Messenger, Tinder, Bumble, and MeetUp, to name a few.

However, the usefulness of these known software platforms is only in relation to the organizing of the meeting or event, that is the lead up work of the event, and does not extend to the meeting or event itself. Specifically, known software platforms are not concerned with the invitees or indeed the organizer actually showing up for the meeting or event.

Whilst there does exist a number of event or calendar software apps, there is no meeting organization platforms that utilize location tracking technologies in order to check that an invitee or organizer is physically at the meeting or event, that is checking whether a user is at a certain location at a certain time.

Further, software that utilizes location tracking and device handshaking are known and used for a variety of specific applications (for example, ride sharing apps such as Uber). However, there are several technical barriers that are required to be overcome in terms of bringing together the concepts of event organization, location tracking and initiating an electronic transaction based on the event organization and location tracking. As such, the use of “off the shelf” software and algorithms are not feasible to implement such functionality.

### SUMMARY OF THE INVENTION

It is an object of the present invention to overcome or ameliorate at least one of the disadvantages of the prior art, or to provide a useful alternative.

In accordance with a first aspect of the present invention, there is provided a system for selectively implementing an electronic transaction based on proximity detection of a user device, the electronic transaction including primary and secondary parameters. The system includes a central server and a user device having a user I/O interface configured to receive one or more secondary parameters and being in communication with the central server. The user device including a location module for enabling selective location tracking of the user device by the central server. The primary and secondary parameters of the electronic transaction are transmitted to the central server and the central server conditionally preauthorizes the electronic transaction such that if the primary parameters of the electronic transaction are not met, the electronic transaction is implemented based on the secondary parameters. The primary parameters of the electronic transaction include the user device being within a predefined distance of a predefined location by a predefined time.

In an embodiment, the electronic transaction includes a pecuniary transaction. In a further embodiment, the secondary parameters are transmitted from the user device and the secondary parameters include a pecuniary bid amount and a bid amount recipient whereby the pecuniary transaction includes the bid amount being transferred to the bid amount recipient. In a yet further embodiment, the bid amount recipient is a nominated charitable organization.

In an embodiment, the user I/O interface is configured to receive the primary parameters and the primary parameters and transmitted to the central server from the user device.

In an embodiment, the conditional pre-authorization of the electronic transaction is such that the electronic transaction is implemented substantially immediate at the predefined time.

In an embodiment, the electronic transaction is implemented by the central server independently of the user device.

In an embodiment, the user device is a mobile smartphone.

In an embodiment, the location module provides Global Positioning System (GPS) functionality whereby determining if the primary parameters are met includes tracking the location of the user device by way of GPS. In a further embodiment, the location module provides short distance communications functionality and determining if primary parameters are met includes the user device being recognised as within range for short distance communications. In a yet further embodiment, the short distance communications functionality includes Bluetooth functionality.

In an embodiment, the predefined location is a location of another user device.

In an embodiment, the central server includes central database having a user sub-database for maintaining user data and an event sub-database for maintaining event data, wherein the primary and secondary parameters of the electronic transaction form at least a part of the event data and/or the user data.

In an embodiment, the user data includes a plurality of registered user profiles.

In an embodiment, the system includes a further user device such that the primary parameters are transmitted to the central server from the further user device.

In accordance with a second aspect of the present invention, there is provided a method for selectively implementing an electronic transaction based on proximity detection of a user device, the electronic transaction including primary and secondary parameters The method includes the steps of receiving by a user I/O interface of a user device, from a user of the user device, one or more secondary parameters; transmitting to a central server, the primary and secondary parameters of the electronic transaction, wherein the primary parameters of the electronic transaction includes the user device being within a predefined distance of a predefined location by a predefined time; conditionally pre-authorizing, by the central server, the electronic transaction; tracking by the central server, the location of the user device by a location module of the user device; and if the primary parameters are met, implementing, by the central server based on the secondary parameters, the electronic transaction.

In an embodiment, the electronic transaction includes a pecuniary transaction. In a further embodiment, the step of transmitting to the central server, the primary and secondary parameters of the electronic transaction, includes transmitting to the central server, from the user device, the secondary parameters.

In an embodiment, the secondary parameters include a pecuniary bid amount and a bid amount recipient whereby the step of implementing the electronic transaction includes transferring the bid amount to the bid amount recipient. In a further embodiment, the bid amount recipient is a nominated charitable organization.

In an embodiment, the user I/O interface is configured to receive the primary parameters and the step of transmitting to the central server, the primary and secondary parameters of the electronic transaction, includes transmitting to the central server, from the user device, the primary parameters.

In an embodiment, the step of conditionally pre-authorizing the electronic transaction includes substantially immediately implementing the electronic transaction at the predefined time.

In an embodiment, the conditional step of implementing the electronic transaction by the central server is carried out independently of the user device.

In an embodiment, the user device is a mobile smartphone.

In an embodiment, the location module provides Global Positioning System (GPS) functionality whereby determining if the primary parameters are met includes tracking the location of the user device by way of GPS. In a further embodiment, the location module provides short distance communications functionality and determining if the primary parameters are met includes the user device being recognised as within range for short distance communications. In a yet further embodiment, the short distance communications functionality includes Bluetooth functionality.

In an embodiment, the predefined location is a location of another user device.

In an embodiment, the central server includes central database having a user sub-database for maintaining user data and an event sub-database for maintaining event data, wherein the primary and secondary parameters of the electronic transaction form at least a part of the event data and/or the user data. In a further embodiment, the user data includes a plurality of registered user profiles.

In an embodiment, the step of transmitting to the central server, the primary and secondary parameters of the electronic transaction includes transmitting to the central server the primary parameters from a further user device.

In accordance with a third aspect of the present invention there is provided computer system including a processor configured to perform a method according to the second aspect.

In accordance with a fourth aspect of the present invention there is provided a computer program product configured to perform a method according to the second aspect.

In accordance with a fifth aspect of the present invention, there is provided a computer readable medium carrying a set of instructions that when executed by one or more processors cause the one or more processors to perform a method according to the second aspect.

Other aspects of the present disclosure are also provided.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

These and other objects, advantages and features of the invention will become apparent upon review of the following specification in conjunction with the drawings.

### BRIEF DESCRIPTION OF THE DRAWINGS

One or more embodiments of the present disclosure will now be described by way of specific example(s) with reference to the accompanying drawings, in which:

FIG. 1 is a schematic representation of a system according to an embodiment of the invention;

FIGS. 2A to 2M collectively represent a user flow of the system of FIG. 1;

FIG. 3 is a graphical representation of a user device of the system of FIG. 1 showing an example screen graphic according to an embodiment of the invention;

FIG. 4 is a graphical representation of a user device of the system of FIG. 1 showing an example screen graphic according to an embodiment of the invention;

FIG. 5 is a graphical representation of a user device of the system of FIG. 1 showing an example screen graphic according to an embodiment of the invention;

FIG. 6 is a graphical representation of a user device of the system of FIG. 1 showing an example screen graphic according to an embodiment of the invention; and

FIG. 7 is a graphical representation of a user device of the system of FIG. 1 showing an example screen graphic according to an embodiment of the invention.

### DESCRIPTION OF THE PREFERRED EMBODIMENTS

Where applicable, steps or features in the accompanying drawings that have the same reference numerals are to be considered to have the same function(s) or operation(s), unless the contrary intention is expressed or implied.

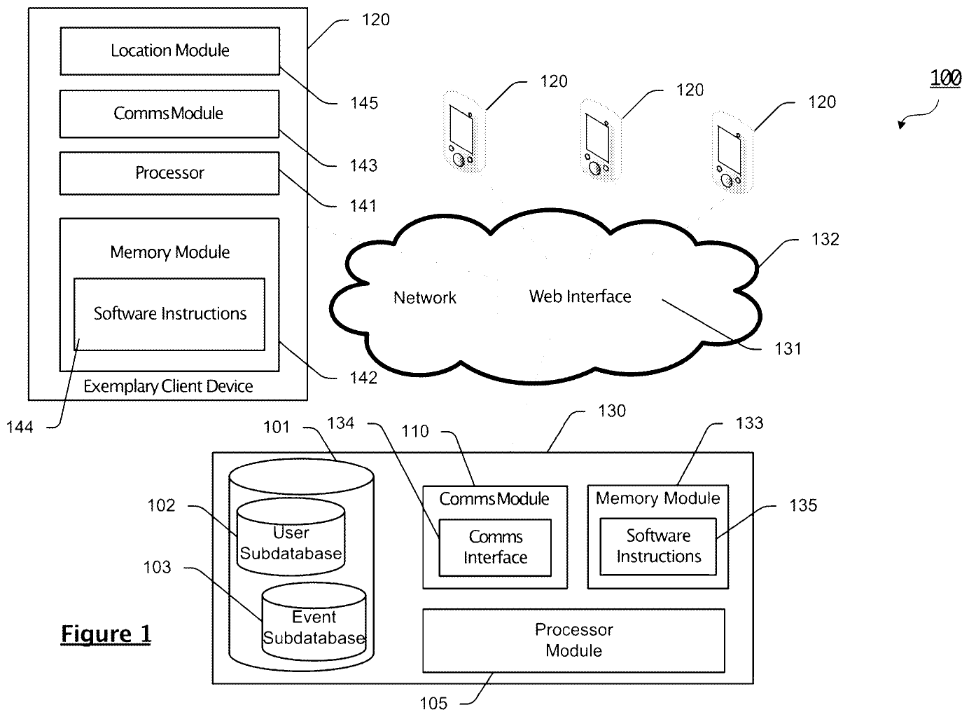

Referring initially to FIG. 1, the present disclosure provides a system 100 for selectively implementing an electronic transaction based on proximity detection of at least one user device. System 100 includes a central web server 130 having a central database 101 which in turn includes: a user sub-database 102 for maintaining user data; and an event sub-database 103 for maintaining event data. User data includes a plurality of registered user profiles, with each registered user profile corresponding to a registered user of system 100. Server 130 further includes a processor module 105 that is coupled to and in communication with database 101. Further included is a server communications module 110 for facilitating communications functionality to a plurality of user devices 120.

Looking more closely at the architecture of embodiments, methods and functionalities considered herein are implemented by way of server 130, as illustrated in FIG. 1. In overview, server 130 provides a web user I/O interface 131 that can be accessed by way of devices 120. In overview, users access user I/O interface 131 over a network 132, such as the Internet, by way of interface terminals 120, which in various embodiments include the likes of mobile smartphones, tablets, PDAs, and other portable and mobile Internet enabled devices that enable location tracking.

Within server 130, processor module 105 is coupled to a memory module 133 and a communications interface 134 of communications module 110, such as an Internet connection, modem, Ethernet port, wireless network card, serial port, or the like. In other embodiments distributed resources are used. For example, in one embodiment server 130 includes a plurality of distributed servers having respective storage, processing and communications resources. Memory module 133 includes software instructions 135, which are executable on processor module 105.

In further embodiments the database leverages memory module 133.

User devices 120 include a screen, in the form of a touchscreen, to display and allow interaction with user I/O interface 131.

In preferred embodiments user I/O interface 131 includes a website. The term “website” includes substantially any source of information accessible over the Internet or another communications network (such as WAN, LAN or WLAN) via a browser application running on a user device including a series of secure websites and/or mobile software applications (apps). In some embodiments, a website is a source of information made available by a server and accessible over the Internet by a web-browser application running on user device 120. The web-browser application downloads code, such as HTML code or Java code, from server 130. This code is executable through the web-browser on user device 120 for providing a graphical and often interactive representation of the website on user device 120. By way of the web-browser application, a user of user device 120 is able to navigate between and throughout various web pages provided by the website, and access various functionalities that are provided. In preferred embodiments, this website functionality is embodied in a purpose built, downloadable app.

In general terms, each user device 120 itself includes a processor 141 coupled to a memory module 142 and a location module 145 having componentry including hardware and software to enable location tracking of user device 120 and at least providing Global Positioning System (GPS), Bluetooth and WiFi based communication and tracking protocols, or the like, for enabling selective location tracking of user device 120 by server 130. Memory module 142 includes software instructions 144, which are executable on processor 141. These software instructions allow user device 120 to execute a software application which allows access to and interaction with user I/O interface 131, by way of a rendered on-screen interface and allows communication with server 130. This rendered user I/O interface allows a user to: create a user profile or log in using an existing user profile; and access to the functionalities of system 100, which will be described in detail below. Each user device 120 may further include a communications module 143 for enabling telephonic and data communications functionality of user device 120 (by way of mobile telephony networks and/or WiFi, amongst others).

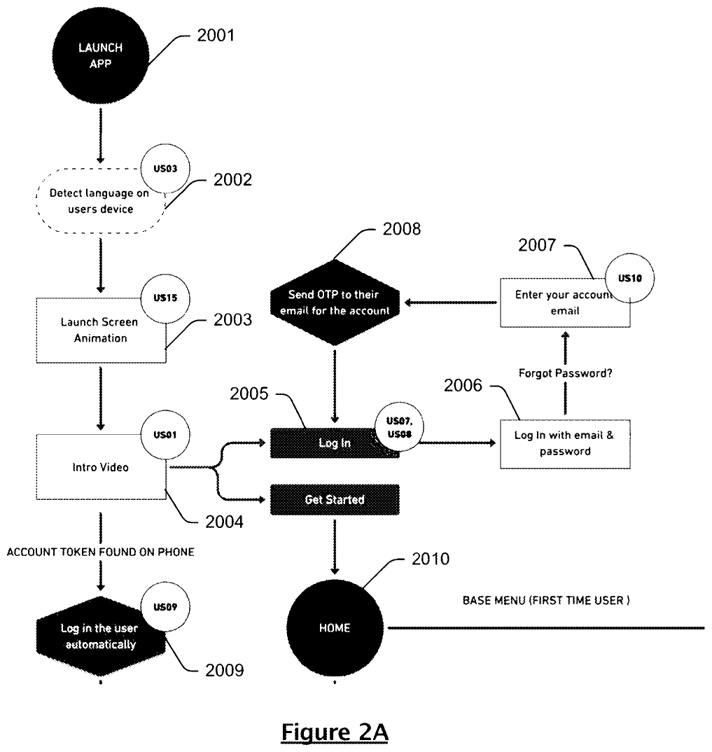

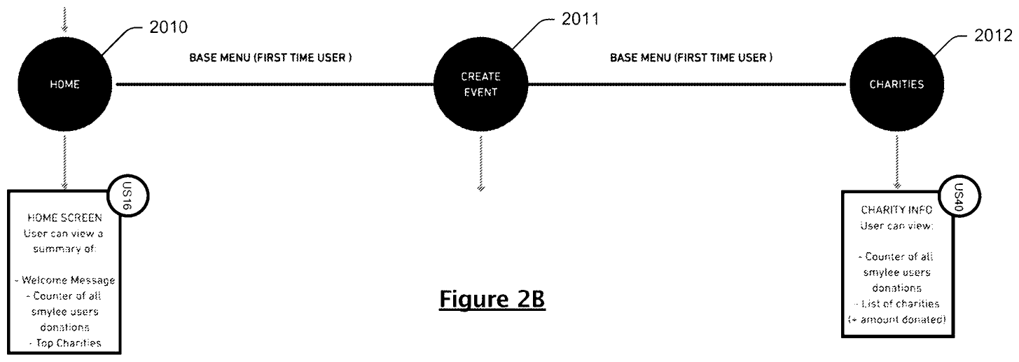

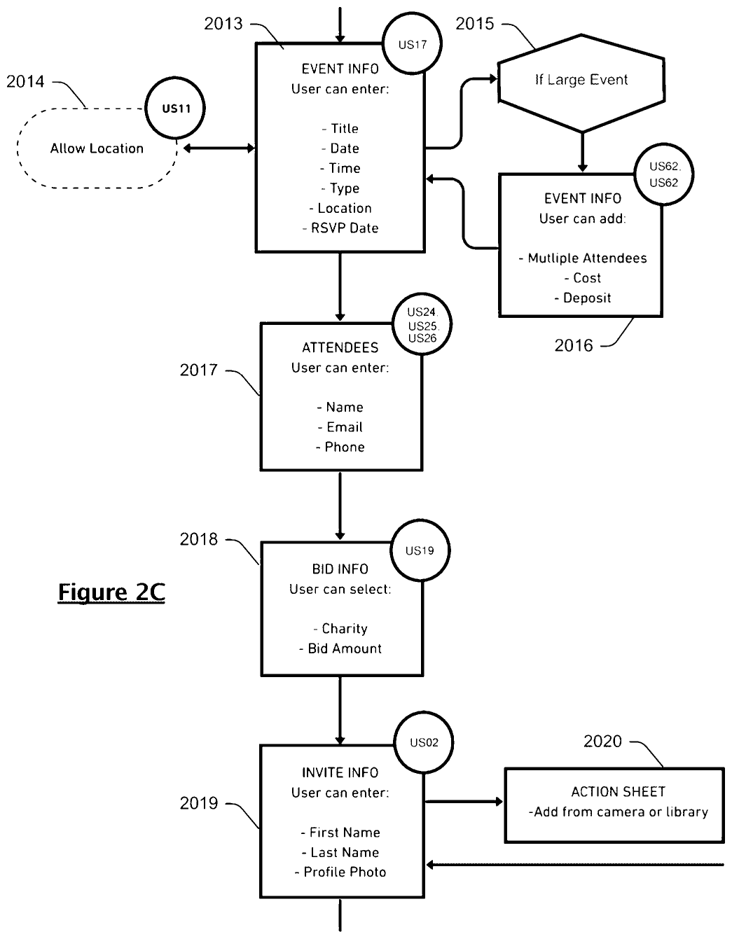

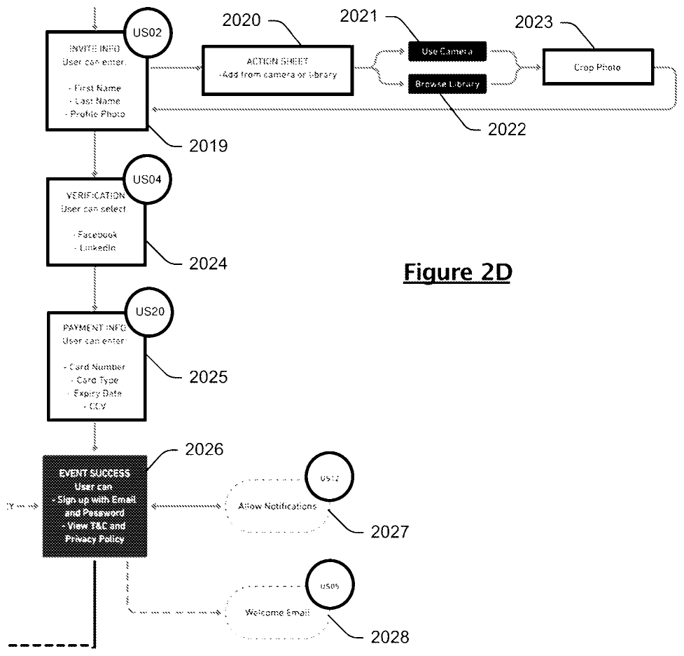

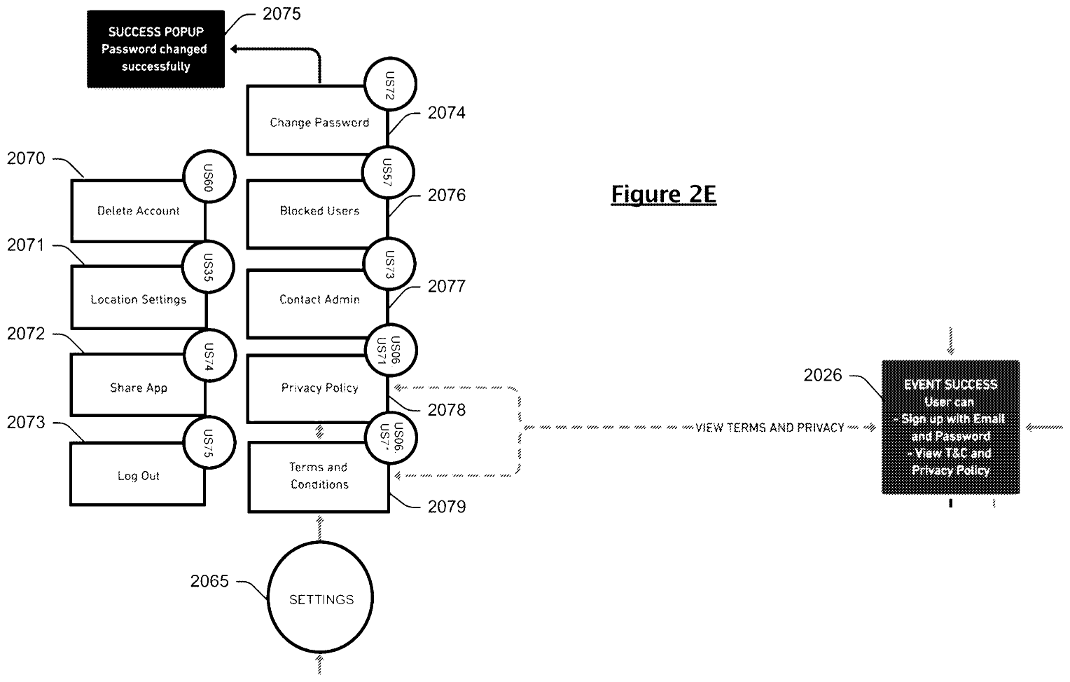

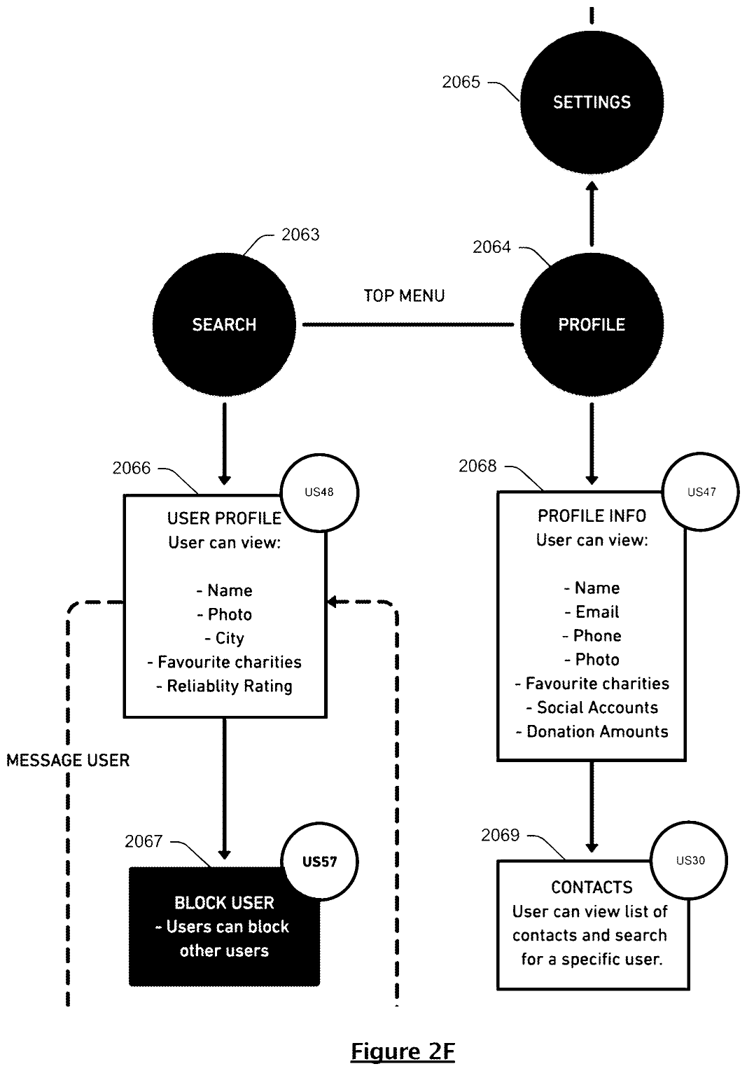

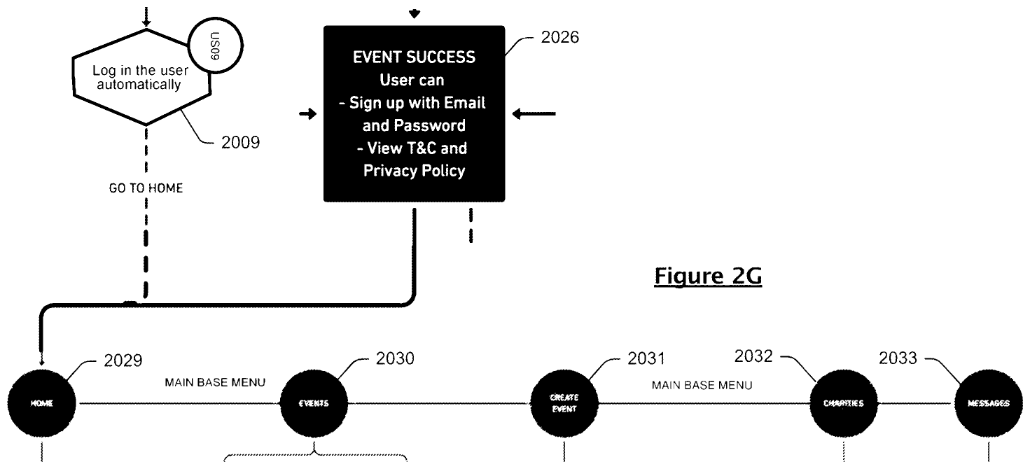

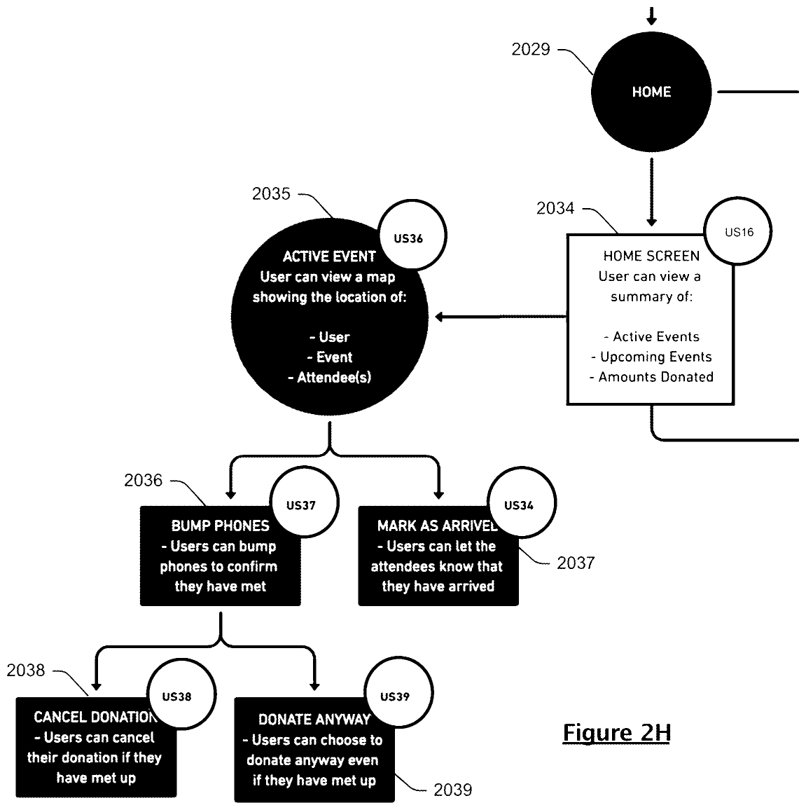

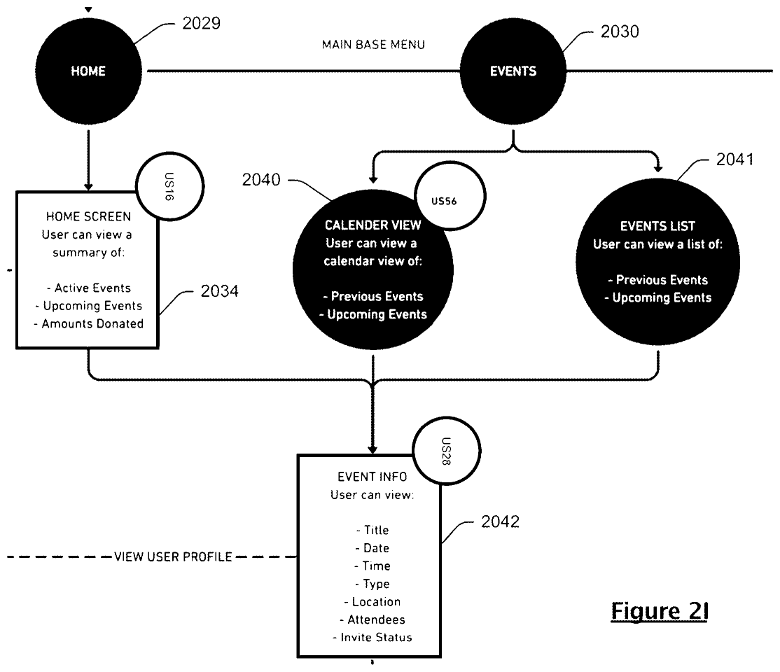

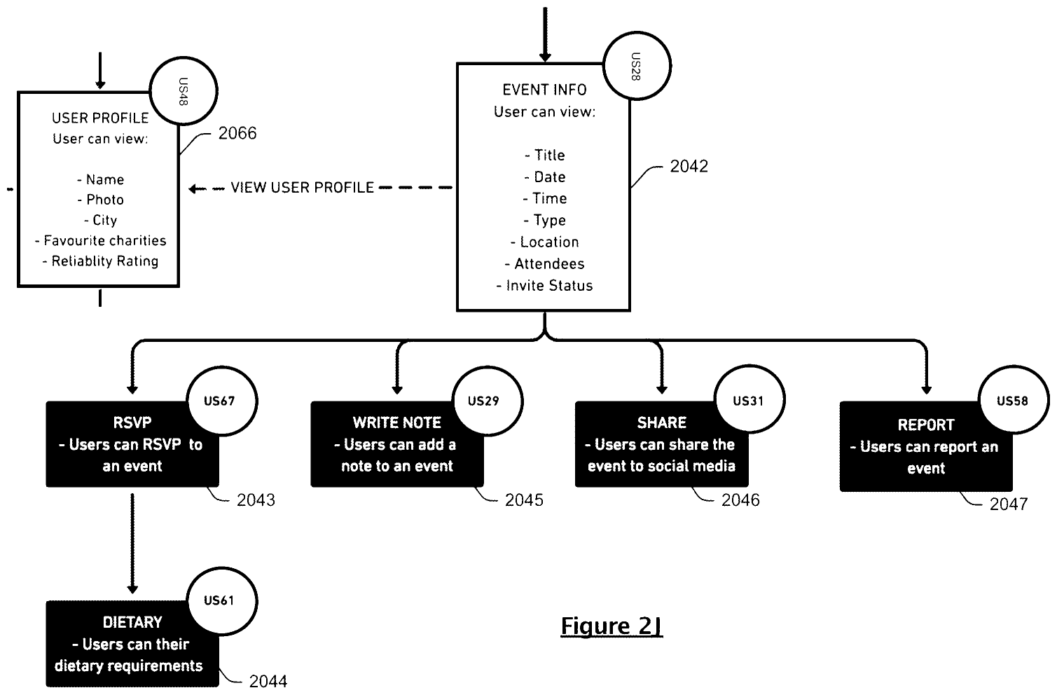

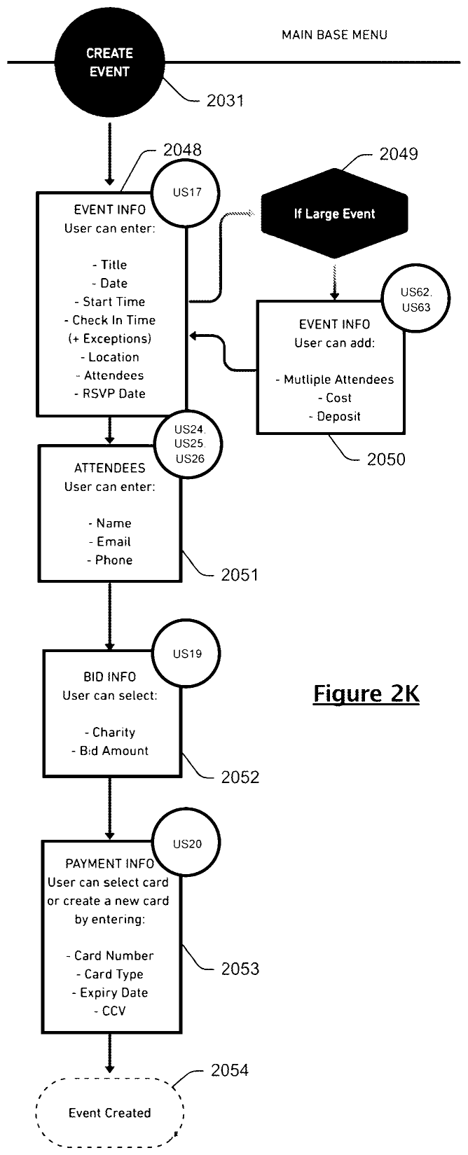

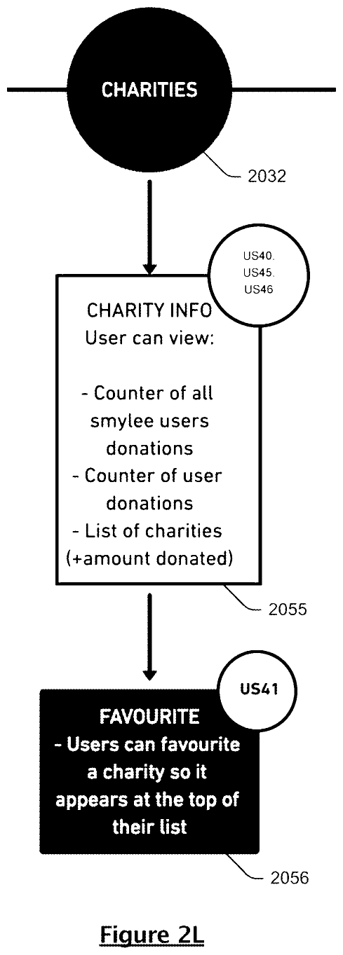

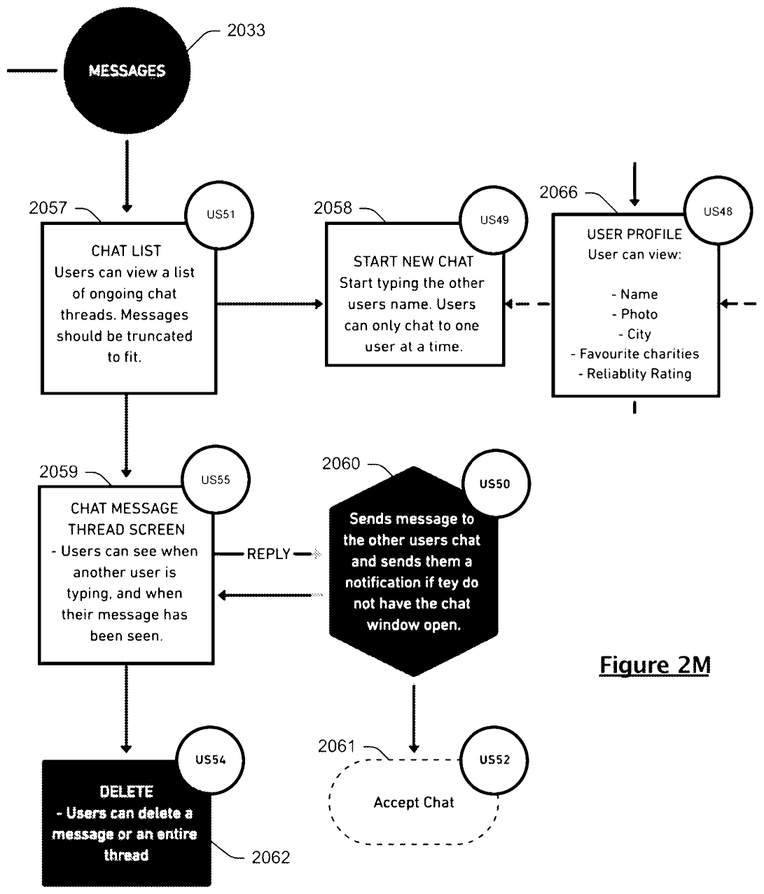

Referring to FIG. 2A, the user of the user device launches the software application at step 2001. At step 2002, the software accesses settings of user device 120 to obtain the language setting so that the interface 131 is displayed in the language set on user device 120. A launch animation is rendered on the screen of user device 120 at step 2003 after which an introduction video is displayed at step 2004. The user can optionally skip the launch animation and introduction video and proceed directly to a login page of user I/O interface 131. For a first-time user, they have the option to create a registered user profile to proceed with using the functionalities of system 100. Each registered user profile includes an email address; a password; a username; a first name; and a surname, all of which will be required to be entered when setting up the profile. Other optional information for the registered user profile includes a profile photo and links to any social media accounts such as a Facebook or LinkedIn account. Once the user is actually using the functionality of system 100, the registered user profile of the user will also include links to one or more events stored in event sub-database 103.

If the user is a registered user, at step 2005, a manual login process is initiated and at step 2006, the user will enter their login credentials in the form of their email address and password as is recorded in their registered user profile. In other embodiments, the username must be entered either in addition to the above credentials or instead of the email address. If the user forgets their password, at step 2007, they can enter their email address in order to receive a one-time password at step 2008 with which they can use to log in.

Alternatively, at step 2009, an account token store on user device 120 will enable an automated login.

If a user has not created a registered user profile, they will be directed to a base menu including a home screen for first time users at step 2010. Referring now to FIG. 213, the home screen provides the following summary information: a welcome message; a counter of donation amounts of all users of system 100; and top charities in terms of donation amounts. The base menu also includes a “create event” option, denoted by reference 2011, and a “charities” section, denoted by reference 2012, the latter of which includes information on charities including a different rendering of the counter of donation amounts of all users of system 100 and a more extensive list of charities including statistics relating to those charities such as total donations, recent donations, and pending pledge amounts (bid amount).

Referring to FIG. 2C, the create event option 2011 directs the user to step 2013 where event data, in the form of information about an event, can be manually entered by the user via user device 120. As illustrated, the user can enter the following fields of an event: title of the event; date of the event; time of the event; type of event (for example a wedding, date, Christmas party, etc.); location of the event; and RSVP date of the event. In preferred embodiments, the time of the event includes a grace period whereby an attendee is allowed a prespecified additional time to arrive at the event that is taken as a set period of time following the time of the event. The event date, time (including grace period) and location form primary parameters of the electronic transaction. As denoted by reference 2014, the location can be checked from a location service so that is corresponds to an actual address recognisable and locatable on an electronic mapping service such as Google Maps or Apple Maps. Further, at step 2015, if the event is a large event (in preferred embodiments, 50 or more attendees), then at step 2016, the user can also enter: multiple attendees; cost (either a total or per attendee amount); and deposit amount.

At step 2017, the user can enter the details of attendees including name, email address and phone number (including international country code, and area code if required). Each invite to an attendee is keyed into the invitees registered user profile by way of deep linking and also includes a unique code to allow a user to move an invite into another account. As invites are sent to the email of an invitee that is actually entered by the user who creates (hosts) the event, this may be a different email address to that invitee's email address used in their registered user profile. In other words, that invitee may have more than one email address and may have already created an account and therefore their registered user profile using an alternate email to the one of which the invite was sent. In this case, the invitee has the option to move the invite to the account created under the different email address. At step 2018, the user can enter a pecuniary bid amount recipient in the form of a chosen charity and a donation bid amount whereby if the user does not arrive on time or attend the event at all, the bid amount will be automatically paid to the chosen charity. The electronic transaction further includes secondary parameters that include the bid amount and the chosen charity.

Referring to FIG. 2D, at step 2019, the user can compile the actual invite that an invitee will receive. This includes entering the users first and last names, along with a profile photo. As denoted by reference 2020, the profile photo can be obtained from an action sheet whereby, at step 2021, a camera on user device 120 can be used to capture an image to be used for a profile photo or, at step 2022, a photo library on user device 120 can be perused and a photo chosen to be the profile photo. At step 2023, the chosen photo can be optionally cropped.

At step 2024, the user can be verified based on another account, such as a social media account, for example a Facebook or LinkedIn account. In this case, credentials will be required to be entered to access the other account, after which certain details from the other account (at least first/last names, email addresses, but also potentially profile photos and other data) will be utilised for the system 100.

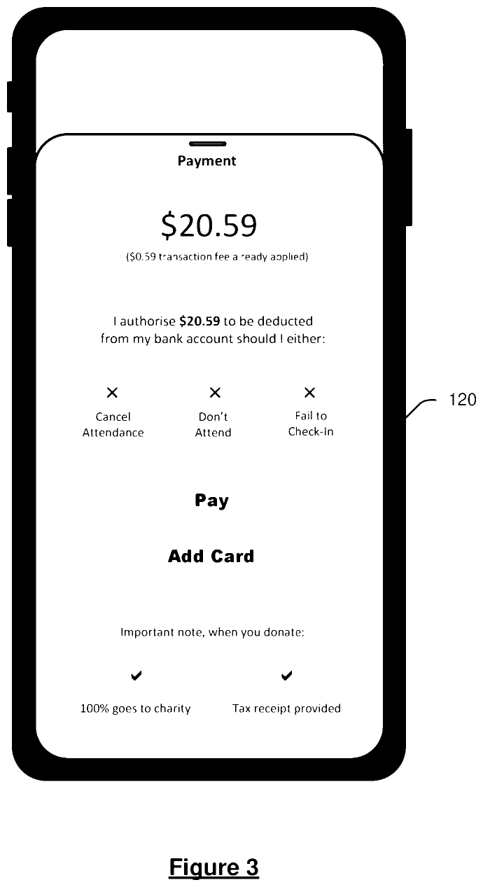

Information for the electronic transaction set up is entered at step 2025. Specifically, payment information is entered in case of the user not arriving on time or not attending the event at all after positively RSVPing, then (from the information entered at step 2018) the bid amount will be automatically paid to the chosen charity from the payment information entered at step 2025. The payment information includes: a credit/debit card number; credit/debit card type; the expiry date of the credit/debit card; and the card verification value (CCV) or card verification code (CVC) of the credit/debit card. At this point the credit card is pre-authorised for donation of the amount and a token for the credit card is saved by central server 130 in order to make payment. A preferred embodiment of the confirmation displayed by user device 120 is shown in FIG. 3, where an amount of $20.59 is placed as the bid amount. All the credit card tokens are stored in database 101 and, as such, the electronic transaction occurs at the server level without requiring the user devices.

The user will have the option at step 2026, once the event has been successfully created, to create a registered user profile by entering further details such as a password and also being provided with the Terms & Conditions and Privacy Policy of system 100. At step 2027, the user will also be prompted to allow the receipt of notifications, and a welcome email will be sent to the email address of the user, as denoted by reference 2028.

Referring to FIG. 2G, either following the automated log in of step 2009 or after an event is successfully created and a registered user profile is set up at step 2026, the user will be directed to a home screen at step 2029 for registered users, that displays a base menu. The base menu includes the following menu items: viewing existing events denoted by reference 2030; creating a new event denoted by reference 2031; view charities denoted by reference 2032; and viewing messages denoted by reference 2033.

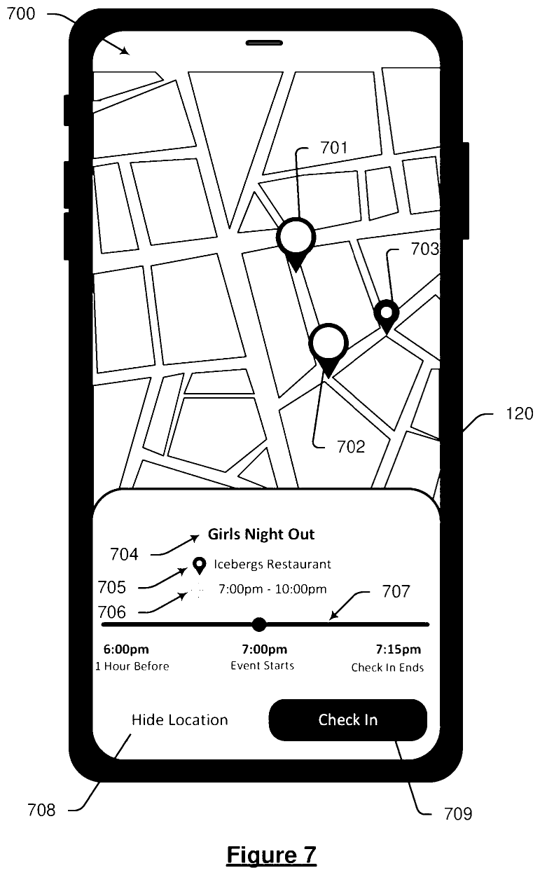

Referring to FIG. 2H, at step 2034, the home screen includes a display summarising: active events; upcoming events; and a list of amounts donated by the user. When the user selects a listed active event, at step 2035, the user can view a map that shows: the location of the user; the location of the event; and the location of attendees. It will be appreciated that the information displayed will depend on each of the respective locations being within a predefined distance of each other. FIG. 7 illustrates user device 120 displaying a map 700 showing user device locations 701 and 702 and event location icon denoted by reference 703, setting out the title of the event denoted by reference 704 (“Girls Night Out”), listing the location denoted by reference 705 (“Icebergs Restaurant”), showing the start and end times of the event (“7:00 pm-10:00 pm”) denoted by reference 706, and showing a timeline 707 of important times in relation to the event, showing the time one hour prior to the event at which the reminder is sent (6:00 pm), the time of the event (7:00 pm) and the time check-in ends, that is the end of the grace period for the user (7:15 pm). There are also options 708 and 709 to respectively hide the user device location (“Hide Location”) and initiate a check-in process (“Check In”).

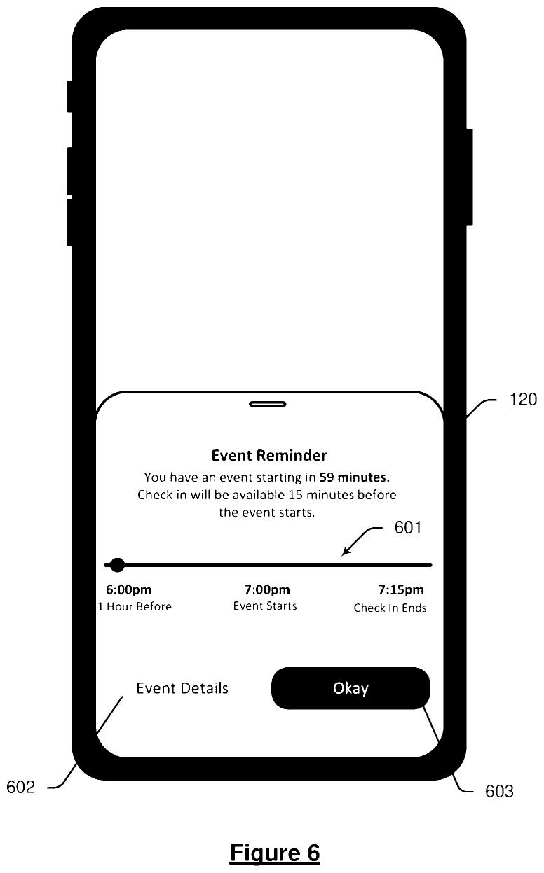

Leading up to the start of an event, reminders are sent to users who are attendees one hour prior to the event time and the users are prompted to turn on their location (if not turned on already) so other attendee users and the host user (that is, the user that has created and set up the event from their respective user device 120) can see the location of user devices 120. FIG. 6 illustrates user device 120 displaying a reminder, noting that the event starts in 59 minutes and check-in (that is, the time a user device can be detected at the event location) is available 15 minutes prior to the event time. A graphic 601 also shows a timeline of important times in relation to the event, showing the time one hour prior to the event at which the reminder is sent (6:00 pm), the time of the event (7:00 pm) and the time check-in ends, that is the end of the grace period for the user (7:15 pm). The location of the user device is then able to be viewed on other user devices attending the event 30 minutes prior to the event time, on approval by each respective user. There are also options 602 and 603 to respectively show the event details (“Event Details”) and clear the reminder (“Okay”). It will be appreciated that in other embodiments, other timings will be utilised.

It is noted that for the purposes of the present invention, it is assumed that the user and their respective user device 120 will be at the same location and that the user will have their respective user device 120 in their immediate possession. As such, the location of the user and their respective user device 120 will be essentially one and the same.

When the user arrives within a predefined radial distance of the event location they are automatically checked in by way of the functionality of location module 145 and its location settings (such as 105 and Android location settings for Phone and Android mobile devices), which includes utilising Bluetooth with respect to the user devices of other attendees if location of the user cannot be accurately determined.

If the user arrives before the event time or grace period then they are not required to donate. Grace periods are unique to each attendee and will vary. In other embodiments, the same grace period will apply to all attendees of the event.

When the user arrives at the location of the active event, the user will be recognised as being arrived at the event. In this case, central server 130 will determine whether the location of user device 120 is within a predetermined distance of the location of the active event.

The functionality of location module 145 includes location tracking to ping user location in respect of other users. This is used to determine proximity to other users as well as proximity to the event location. Further a combination of Bluetooth and GPS technologies are utilised to ensure accurate detection of user devices at a location in both densely populated metropolitan areas (preferably up to within 10 metres) and regional areas where location accuracy can be down to several hundred meters (preferably to within 150 metres or better).

Also, at step 2036 if another attendee or the host is present, the user can use proximity handshake technology such as Bluetooth to “bump” the other attendee's respective user device or host's user device to confirm via electronic handshake that the user has arrived at the event denoted by reference 2037.

In other embodiments, other technologies are used to carry out the handshake, including Airdrop and multilateration technologies.

With regards to the location tracking, an algorithm is utilised whereby user devices 120 are tracked to check in at the event location, but are also tracked in the sense of allowing user devices to check in via the “bump” functionality if they are in proximity another verified user device or devices that are at a different location. As noted above such tracking is accessed via GPS or Bluetooth capabilities of location module 145. Once the event time is reached server 130 carries out checks each minute until the grace period for that user device ends. Even after user device 120 checks in, the location of that user device is still being shared.

User device 120 is confirmed as having arrived at the event location on time if they are checked in either by proximity to the event location or proximity to another verified user device. For the former, this includes GPS location tracking to confirm if user device 120 is within the predetermined distance, in this case 50 metres, of the event location, or within 50 metres of the user device of the host (in the event that the primary location changes close to the event time). If the location of user device 120 cannot be determined and the “bump” functionality is utilised, the arrival is determined by user device 120 being within Bluetooth range with the user device of another attendee of the event so that those devices can carry out a handshake, which is essentially an identification of another device. The other user device will also need to have their location confirmed which can be done by GPS location tracking or if that device has been verified through the verified location of yet another user device of which a Bluetooth handshake has occurred. It is noted that the Bluetooth handshake does not actually connect the user devices or pass any data between the user devices, all that is required is a Bluetooth identity to be recognised. In other words, a check is carried out of the Bluetooth range of user device 120 for any Bluetooth identities of other user devices proximity to another user device is confirmed if the Bluetooth identity of that other user device is recognised.

In other embodiments, for another user device to be verified, they can either be the user device of the host user or a user device that has itself already checked in.

As is well-known in the art, Bluetooth does not pinpoint a standalone location in and of itself, it only communicates with nearby devices which are also Bluetooth enabled. Location module 145 uses Bluetooth to verify that another user device is nearby and within Bluetooth communication range, which provides a secondary way to confirm attendees.

As such, in preferred embodiments, if user device 120 cannot be accurately located, a check is carried out of whether user device 120 is within Bluetooth range of another user device where both users are attending the same event.

User devices that are found to be in the same location, or within Bluetooth range of each other at the end of the relevant grace period are confirmed as successfully checked in. As noted above, this successful check in occurs even if the user devices are not at the actual event location. This is done in case the attendees move the event location close to the event time where it is too late to update the event location within system 100.

It is emphasised that system 100 tracks multiple user devices 120 at once for each event, and each individual user has different arrival timing requirements for each event that are required to be monitored separately. The process of checking the location of user device 120 with respect to the event location is fully automated such that once the event time is reached, the electronic transaction is implemented by server 130. If the automation is unavailable due to coverage issues, location can be verified manually by other either multiple other checked in attendee users or by the host user. Further, both automated and manual verification is used in embodiments. Finally, as the transaction occurs at the server level without requiring input from the user device (and with preauthentication already provided), if system 100 cannot confirm user device 120 has arrived at the event location by the event time then the electronic transaction is implemented independent of the user device.

It is noted that digital distribution platforms from companies such as Apple and Google have very strict policies around tracking the location of their users through their user devices whilst an app is closed and while open. As such, system 100 ensures that the user agrees to their location being disclosed to the platform and to the other attendee users. Although the previously disclosed check is done to see if they are within the predetermined distance of the event location (check in zone) or within proximity of another attendee user, to maintain the privacy of the user, system 100 does not record such checks; this is all done at the user device level for privacy reasons. All that is required is a positive or negative ping back from the user device to validate a check in. System 100 includes checks to compel users to turn on location tracking of their user device in order for their user device to be checked in so that the location can be validated.

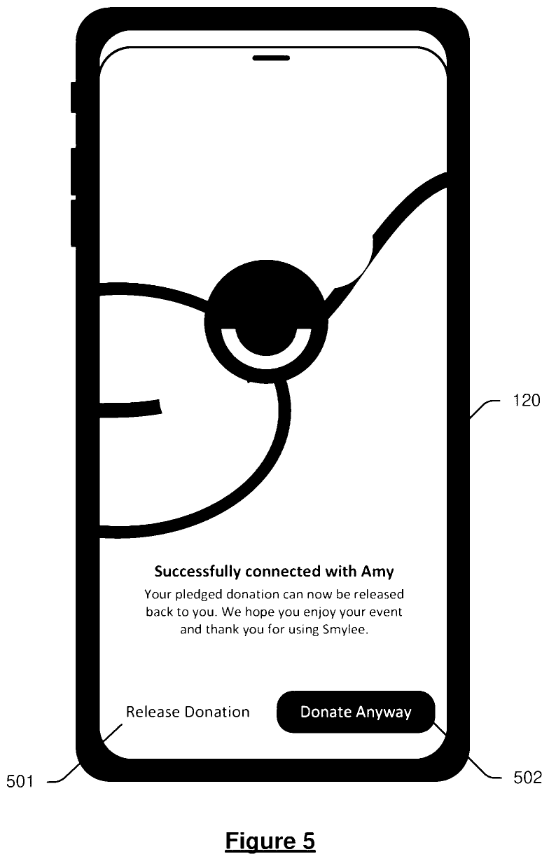

Once the user has confirmed to have arrived within the predefined distance of the predefined active event location by the predefined event time, the user will be prompted to cancel their donation, denoted by reference 2038, or choose to donate anyway even if they have arrived within the predefined distance of the predefined active event location by the predefined event time denoted by reference 2039. FIG. 5 shows a display of user device 120 where that user device has been deemed to have arrived to the event location by the event time. In this illustrated embodiment, the event was organised by user “Amy” and the two options, 2038 and 2039 are shown as selectable options 501 and 502.

If the user does not arrive at the event location by the end of the grace period then the pre-authorised credit card electronic transaction is initiated in order to make the donation by paying the bid amount to the chosen charity.

Referring to FIG. 21, when the user selects the events option (denoted by reference 2030) they can toggle between a calendar view denoted by reference 2040 and an events list view denoted by reference 2041. The calendar view renders a calendar style graphic of events including previous events and upcoming events. The events list view simply lists the previous events and upcoming events. For an event in the displayed or listed events from 2040 and 2041 respectively, the user can select a single event at step 2042, which in turn displays event information retrieved from subdatabase 103 including: the title of the event; the date of the event; the time of the event (including grace period); the type of event; the location of the event; the attendees; and the invite status of the user in relation to the event.

Referring to FIG. 23, from the event information screen 2042, the user is able to: RSVP to the event denoted by reference 2043, including optionally specify dietary requirements (denoted by reference 2044); write a note to be added to the event denoted by reference 2045; share the event to their social media account denoted by reference 2046; and report the event denoted by reference 2047. Reporting the event entails the user to flag the event as spam, inappropriate, offensive or dangerous, for example, in the cases of stalking or profanity. A software application administrator of system 100 can then choose to block the offending user/user device and remove the event from system 100. In other embodiments, users can also specify other related event items such as what to bring to the event and car-pooling requests.

For an event where the user is the host user, that host will have the option to remind users of the hosted event in advance of the event date and time. For example, at step 2042 where the attendees of the event are viewable, there is a selectable option to send an event reminder to all attendees of the event. This option will trigger the user to be displayed with the attendees who have not RSVP′d to the event and, based on this, the host user is able to manually include attendees to be sent the event reminder or exclude attendees from being sent the event reminder. If there are more than 20 attendees to be sent the event reminder, the host user will be visually informed of the smart phone limitations of the reminder. It will be appreciated that smart phones have limits on the amounts of contacts to whom you can send a single SMS, for example, Apple and some Samsung smart phones have a limit of 20 contacts at a time. For the example of Apple smart phones, if there are more than 20 attendees to be sent the event reminder by SMS, the host user will be visually informed of the smart phone limitations. In such circumstances, the host user is directed to an SMS application on device 120 where a template reminder message is prepared for sending to each selected attendee to be reminded. Further, the attendee list also shows a count for the number of times each attendee has been sent an event reminder. In an embodiment, this count is shown in place of the attendees email address or phone number, for example “1 Sent”, “3 Sent”, etc.

Referring to FIG. 2K, when the user selects the create event option (denoted by reference 2031) from the base menu of FIG. 2G, at step 2048 they are directed to enter similar details to step 2013. As illustrated, the user can enter the following fields of an event: title of the event; date of the event; start time of the event (including grace period); end time of the event including any exception to this end time; location of the event; attendees of the event; and an RSVP date. Further, at step 2049, if the event is a large event (50 or more attendees), then at step 2050, the user can also enter: multiple attendees; cost (either a total or per head); and deposit.

At step 2051, similar to step 2017, for each attendee, the user can enter: an attendee name; an attendee email address; and an attendee telephone number. As with step 2017, each invite to an attendee is keyed into the invitees registered user profile by way of deep linking and also includes a unique code to allow a user to move an invite into another account. At step 2052, similar to step 2018, the user can enter a chosen charity and a bid amount whereby if the user does not arrive on time or attend the event at all, the bid amount will be automatically paid to the chosen charity.

At step 2053, similar to step 2025, an electronic transaction is set up. Specifically, payment information is entered in case of the user not arriving on time or not attending the event at all after positively RSVPing, then (from the information entered at step 2052) the bid amount will be automatically paid to the chosen charity from the information entered at step 2053. The payment information includes: a credit/debit card number; credit/debit card type; the expiry date of the credit/debit card; and the card verification value (CCV) or card verification code (CVC) of the credit/debit card. The event is then officially created, denoted by reference 2054. Similar to step 2025, at this point the credit card is pre-authorised for donation of the amount and a token for the credit card is saved by central server 130 in order to make payment.

Referring to FIG. 2L, when the user selects the view charities option (denoted by reference 2032) from the base menu of FIG. 2G, at step 2055 they can view information above charities to which donation have been made. Such information displayed includes: a counter of all users' donations; a counter of the user's own total donations; and a list of charities, including the total amount donated to each. At step 2056, the user can optionally select a favourite charity that will be brought to the top of any list of charities displayed to the user.

Referring to FIG. 2M, when the user selects the view messages option (denoted by reference 2033) from the base menu of FIG. 2G, at step 2057 users can view a list of chat threads in which they are involved. On this summary screen, the list will truncate messages to fit the display. From here, the user can start a new chat thread at step 2058 with another user. In this embodiment, a chat can only be with one other user at a time. However, in other embodiments, the user can chat with multiple other users. As will be explained later, the user can search for another user and proceed to step 2058 to initiate a new chat.

From chat list 2057, the user can navigate to the chat message thread screen denoted by reference 2059 where the user can see when another user is typing and when the user's message has been seen. If the user replies to a message with their own message, at step 2060, the message is sent to the other user's chat and that other user is also sent a notification if they do not have the chat screen 2059 open. This officially accepts the chat between two users, denoted by reference 2061. The user also has the potion to delete a message or an entire chat thread, denoted by reference 2062. In preferred embodiments, users can continue to communicate in the chat thread after the event has occurred and can upload images (of the event or otherwise) into the thread.

Referring now to FIG. 2F, on the main base menu, there also exists a top menu that is visually disposed at the top of the screen, above the main base menu. The top menu includes three selectable choices: a search option denoted by reference 2063; a profile option denoted by reference 2064 and a settings option denoted by reference 2065.

If search option 2063 is selected, the user will be asked to manually enter search parameters for which a search of sub-database 102 will be carried out and one or more users (each having registered user profiles) may be returned from the search, otherwise the search will return no results. As denoted by reference 2066, the user or users that are found in the search will have the following information displayed as retrieved from sub-database 102: the user name; the user profile photo; the city where the user is located; the user's favourite charities; and the user's reliability rating (this will be discussed in more detail below). As noted above, for any user returned from the search option, the user can proceed to step 2058 (shown on FIG. 2M) to initiate a new chat with that returned user. Further, the same information as seen at 2066 will be displayed from step 2042 in respect of each of the attendees of a selected event (as shown in FIG. 2M). Further, at step 2067, the user has the option to block any other user.

If profile option 2064 is selected, the user will be displayed their profile information at step 2068. Specifically, the following information is displayed: name; email address; telephone number (including international country code, and area code if required); user profile photo; favourite charities; linked social media accounts; and a list of donation amounts. When the user enters their phone number during the creation of their profile the flag/country pertinent to their phone number is chosen which upon input automatically associates and then auto-formats the phone number with the requisite country code. At step 2069, a list of the user's contacts within the software application is also displayed (which includes name and phone number) along with functionality to search those contacts. If any of the user's contacts within the software application do not have a country code, they will be automatically matched to the country code of the user as a default. Further, the software application is also able to access contacts stored on device 120.

It will be appreciated that potential attendees can also be invited from the list of the user's contact for an event that the user is hosting, in addition to entering in attendee details as at step 2051. More specifically, when viewing an event (such as at step 2042) that the user is hosting, three options will be provided under the broad heading of ‘Add Guests’, those being:
1. Contacts—which includes a search function titled for searching both the user's contacts within the software application and any contacts stored on device 120 in order to include contacts as attendees.
2. Groups—which includes certain user contacts within the software application that have been allocated a group, for example, a “work colleagues” contact group, in order to include groups of contacts as attendees. There is also the option to add a new group and add contacts to the new group.
3. By Email—which includes the ability to add an attendee by manually entering an email address which will automatically obtain other information such as name and phone number if such information is available in relation to the entered email address. Otherwise, the other details are entered as at step 2051.

Once an attendee is added to an event, this will be added to a separately displayed panel to accumulate added attendee such that a list of added attendees is displayed to the host user.

The host user is also able to allow one or more attendees of their hosted event to extend their invite to one additional attendee of the invited attendees choosing, referred to as a “plus 1”. Such an option is toggled on or off for each attendee. When the attendee is prompted to accept an invitation, the invited attendee is able to accept to bring their additional attendee if the host has offered that option or the invited attendee is able to decline bringing an additional attendee. If the attendee choosing to accept to bring their additional attendee, the first name, last name, and any dietary requirement must be provided to the host user for that additional attendee. The invited attendee is able to amend their “plus 1” attendee name and dietary requirements at any time including if they wish to change their “plus 1” attendee to a different person altogether.

The invited attendees donation will not be affected by their “plus 1” attendee and will be made in the fashion described above in the case where there is no “plus 1” attendees. Further, there is no requirement to check in “plus 1” attendees. As “plus 1” attendees are linked to the invited attendee, they will have the same arrival timing requirements for check ins as the invited attendee.

Further, the event information displayed at step 2042 page is updated to show any “plus 1” attendees and show the invited attendee to which they are linked. There is no requirement for any “plus 1” attendees to have a photo attached.

When the user who is an attendee views the event (such as at step 2042) to which they are invited, in an embodiment, there is an option to invite a “plus 1” attendee which will be displayed. When this option is selected, the user will be displayed with fields to enter the details of their chosen “plus 1” attendee, after which they can send an invitation to that chosen “plus 1” attendee in the same fashion as the above described event invites for an invited attendee.

Event information includes a holding state for any “plus 1” attendees that have not yet been formally invited, so that all other attendees are able to see who has been allocated a “plus 1” attendee, but has not yet invited a “plus 1” attendee. This holding state will be similarly displayed as attendees that have yet to RSVP to the event.

Any user who is an invited attendee with an allocated “plus 1” attendee that attempts to RSVP (as at step 2043) without adding their “plus 1” attendee will be prompted with a notification that their “plus 1” attendee has not been added with options to either add a “plus 1” attendee later to continue the RSVP or navigate the user to the option to add their “plus 1” attendee.

It will be appreciated that the host user of an event is able to remove the option for an invited attendee to invite a “plus 1” attendee at any time, as long as the “plus 1” attendee has not yet RSVP′d. This essentially removes the ability of the invited attendee to add a chosen “plus 1” attendee after such an option was provided to the invited attendee. If a “plus 1” attendee has already been sent an invite, that invite will become invalid that “plus 1” attendee attempts to RSVP to the event, and the “plus 1” attendee will receive a message informing them as much.

It will be appreciated for embodiments where device 120 is a smartphones (including Apple and Android phones) there are a number of inbuilt pipelines that third party software applications on device 120 can use to access the services of the smartphone, including the contacts stored on device 120. The inbuilt pipelines the smartphone operating system default method of third party applications accessing contact information stored on the smartphone. For example, the Whatsapp application maintains a persistent connection across all inbuilt pipelines which enables the Whatsapp application to keep the contacts within the application up to date, based on contacts on the smartphone. However, such applications that maintain a persistent connection can cause other applications on the smartphone to be blocked from using these pipelines. As such, the software application of system 100 includes a custom pipeline that is only usable by the software application of system 100 to access the contact stored on device 120 and work around applications such as Whatsapp. The software application of system 100 is further configured to clear maintained connections for applications such as Whatsapp to enable the custom pipeline to be utilised.

Referring to FIG. 2E, if settings option 2065 is selected, the user will be displayed their personal software settings including options to: delete their registered user profile or user account denoted by reference 2070; view their location settings and allowances denoted by reference 2071; share the software application with a non-user via alternate communications channels such as email, SMS or another messaging service denoted by reference 2072; log out of their account denoted by reference 2073; change their password denoted by reference 2074, with a successful password change confirmed with a pop-up message as illustrated and denoted by reference 2075; view a list of blocked users denoted by reference 2076; contact an administrator denoted by reference 2077; view the privacy policy denoted by reference 2078; and view the terms and conditions denoted by reference 2079. It is noted that privacy policy 2078 and terms and conditions 2079 are what is provided at step 2026.

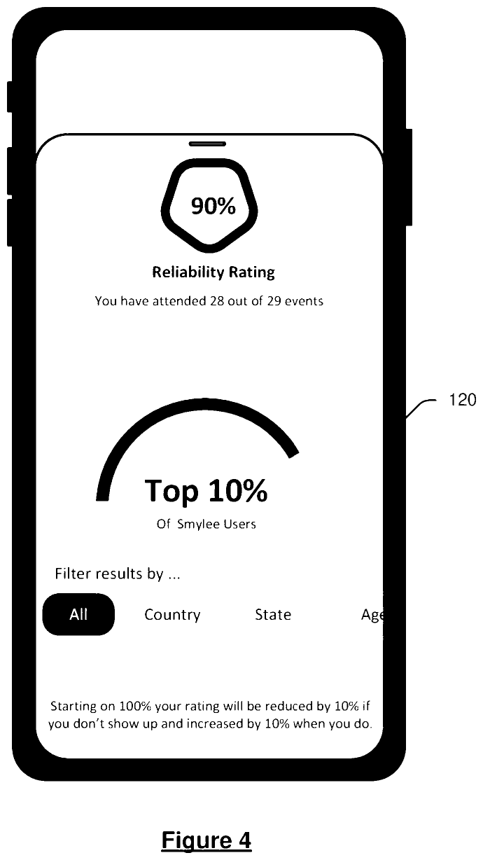

As noted above, each user has a reliability rating in the form of a rating percentage that is determined through an algorithm that aims to reward attendance and changes in behaviour without penalising users over the long term for mistakes. In embodiments, a user's reliability rating will initially be 100% and they will lose 10% each time the user does not attend an event for which they RSVP′d. So, for example, a reliability rating will be 0% if a user does not attend ten events in a succession for which they RSVP′d. If the user reliability rating drops below 100% they can gain 10% when they do arrive at a future event by the event time. It is noted that a reliability rating is a maximum of 100% and a minimum of 0%. FIG. 4 shows a display on user device 120 of a reliability rating of the user of 90% and noting that they have attended 28 out of 29 events to which they have RSVP′d and they are in the top 10% of all users in terms of reliability rating. A user will have the option to view the history of another user's past attendances or non-attendances which is used to show a pattern of reliability. An example of the data show is in the table below:

| Event | User Rating After Event | Attendance |
|---|---|---|
| Event 1 | 100% | New user |
| Event 2 | 90% | No show |
| Event 3 | 100% | Show |
| Event 4 | 90% | No show |
| Event 5 | 80% | No show |
| Event 6 | 90% | Show |
| Event 7 | 100% | Show |

As shown in the table, the particular user attended their first event, event 1 as a new user and therefore had a reliability rating of 100%. The user then RSVP′d to Event 2, but did not attend (i.e., “no show”) so their reliability rating dropped by 10% to 90%. The user then RSVP′d to Event 3 and did attend (i.e., “show”) so their reliability rating increased by 10% back to the maximum reliability rating of 100%. The user then RSVP′d to Event 4, but did not attend (i.e., “no show”) so their reliability rating dropped by 10% to 90%. The user then RSVP′d to Event 5, but did not attend (i.e., “no show”) so their reliability rating dropped by 10% to 80%. The user then RSVP′d to Event 6 and did attend (i.e., “show”) so their reliability rating increased by 10% to 90%. The user then RSVP′d to Event 7 and did attend (i.e., “show”) so their reliability rating increased by 10% to the maximum reliability rating of 100%. It will be appreciated that the reliability rating is not influenced at all by any “plus 1” attendees.

In embodiments, users can view information comparing their own reliability rating to others through a chosen filter by certain demographics. For example, the user can compare their own reliability rating to others: within the same country; within the same State; within the same postcode; or within the same age range.

The payment of the donation (the electronic transaction) involves predetermined timed payments which will occur at the time of the event or after the expiry of a grace period whereby a donation is made consisting of the donation bid amount. The entire bid amount is sent to a set of accounts of the chosen charity, and a co-branded receipt is sent to user device 102 and to the charity receiving the donation to formally confirm the transaction. The transaction is also recorded by server 130. The set of accounts of the chosen charity includes a donations account with the charity can draw on and a service fee account for fees paid to the administrator. The payments need to remain in these accounts for one month to allow for possible refunds to occur, which essentially unsplits the payments back to the user's credit card.

The service fees of the charity are independent of the donations. In other embodiments, the service fees of the charity are linked to the donations received in that a portion of each donation forms the service fee. In preferred embodiments, once per month the administrator will provide a report to each charity detailing donations and service fees incurred as well as details of users who donated. In some embodiments, such a report is transferable to the charities' customer relationship management (CRM) system and/or their financial system.

The payment of the donation, due to the multiple accounts and multiple timings of payment, necessarily includes split payments with a split delay. Splits are relatively commonplace, but split delays are not. As set out above, at a first predefined time (corresponding to the time of the event or the end of the grace period) the full donation bid amount is paid into the chosen charity's set of accounts on donation and then the split into the donations account and the service fee account. At a second predefined time, in the preferred case a specified day of each month, a secondary payment is made to deduct fees from the service fee account to the administrator. As such, these payment timings that can be irregular do invite additional processing and authorisation complexities over known systems. In order to hold the pre-authorisation open, there is a need to re-ping payment gateways at set intervals in the event that payment timings are spread further apart than standard pre-authorisation timeframes, which is typically one to two hours.

The payment split is done within system 100 rather than at an individual payment by payment level which reduces transaction costs. The funds in the charity accounts are also still accessible by the administrator to enact any refund requests which ordinarily presents difficulties when splitting funds with third parties.

It will be appreciated that time and date of an event is particularly important as that will determine when the pecuniary transaction is executed. The time and dates takes into account time zone requirements, and notifications are based on the time and date at the event location rather than a user location. For example, an attendee based in a one time zone can be invited to an event in another different time zone. In this case, the attendee will be notified at the correct time (taking into account the different time zones) based on the time at the event location. Further, when syncing an event to a native calendar of device 120, the time zone of the event location is accounted for which may different from the present time zone of the user location. It is emphasised that the check-in process is trigger based on the time zone of the event location.

System 100 utilises a specific payment platform for managing payments. In preferred embodiments the payment platform utilised is Stripe. Payment made are able to be handled in multiple currencies and take into account location-based tax and fee calculations and management. The system will send bid amounts to the chosen charities that are connected with the stripe account of that country.

After a donation payment is made, a receipt is emailed to the user that conforms to all the relevant country's receipt regulations and requirements.

It will be appreciated that monetary values within the software application of system 100 are displayed alongside an associated currency symbol and currency code associated with the region-based charity group (which is defined by the user location) that are available to the user.

It will be appreciated that, typically, software applications connect to a single payment gateway or payment service for all payments and pays everything to a single account. Standard generic technologies for software applications are set up to pay to one account using one gateway. If funds are required to go to multiple other accounts, they will initially be transferred to the first single account and will then be transferred (or split out) to the other one or more accounts from the first account. Such payments to multiple accounts will therefore often be a multi-stage process which can cause additional fees to be incurred for each transfer that takes place, including for example currency conversion costs and multiple gateway fees. System 100 is uniquely configured to avoids such additional costs and fees, by its ability to pay to different accounts in the same transactions. It does so by arranging the splitting of costs within system 100 and engaging and disengaging gateway connections on the fly. For example, payment providers (such as Stripe) set up connections such that each application is only assumed to be in communication with a single account with the provider, and authentication processes are carried out on this basis. Therefore, system 100 is uniquely customised to allow the authorisation process to be re-done for every connection and therefore communication with multiple accounts in multiple currencies on an order-by-order basis as is required herein.

The software application includes a number of instances of animations being used mainly for transitions between content, for the introductory video explaining the core features, and for animation of logos. Due to mobile data constraints, the entire software application size is required to be under 50 MB. This allows the software application to be downloadable using mobile data when not connected to a Wifi network. If standard video files or animation sprite sheets were used, this would greatly exceed 50 MB. As such, the inventors created scripts to convert animations into vector algorithms in JavaScript Object Notation (JSON) format. This provides significant reduction in the file size of animations to in turn reduce the file size of the entire software application. The created scripts are compatible with existing technology to allow looping and control of the animations, so they can be seed up, or slowed down as well as the playhead being controlled in order to jump frame location and loop back and forth. The created scripts also to allows running the animations on 105 and Android with the same React Native Codebase. Existing technologies that covert vector animations to JSON format have performance issues on Android, and do not provide the same level of control over the animation actions.

In further embodiments, system 100 includes its own a CRM system that enables event bookings to be made and donations paid upon cancellation. In yet further embodiments, donations can be made in multiple currencies and languages to verified charities in other countries.

### Advantages of Detailed Embodiments

It will be appreciated that systems and methods described herein are advantageous over known generic systems through the combination of specific hardware (including mobile user device having location tracking capability) and specific software which initiates an electronic payment transaction primarily based on the user device being in a specific physical location by a specific time. Therefore, the invention entails more than just the pure software existing in a computer device, at the very least due to the fact that the physical location of the user device (which is variable and therefore must be constantly monitored during the necessary time period) is integral to the functioning invention.

It will be appreciated that systems and methods described herein provide at least the follow advantages over known systems:
Allows multiple user devices to be simultaneously tracked for each event.
Each event has different check-in timing restraints for each individual user and these check-in exception times that are separately monitored.
Multiple modes of location verification of a user device, that is, by proximity to the event location by way of GPS tracking, or if their location cannot not be validated, Bluetooth handshake with another user device attending the same event.
The ability to determine with a high degree of accuracy (and that high degree of accuracy being able to be repeated at an equally high level) the location of a user device to within 10 metres in a metropolitan area and up to 150 metres in a regional area using a unique combination of technologies. This is crucial as this triggers the monetary transaction to be carried out or not.
The ability to predict geographical position based on a series of technologies including “piggybacking” off the user devices of other attendees of the event.
Dynamic updating and recording of user device location whilst fulfilling privacy requirements.
Facilitate as many valid user device check-ins as possible across various device types (for example makes and models of mobile telephones), across various operating systems, in the largest possible range of GPS availability in order to avoid user complaints.
Delivering a highly functional vector animation image set within the software application within the total target size limit of 50 MB with the use of JSON image rendering, resulting in increased performance across all platform technologies and ensure the ability to download the software application through mobile data while away from a WiFi network.
The ability to hold and then transfer funds to either a chosen charity (or back to the user) within the predetermined irregular time frames which are reliant on the event time and date.
The minimising of transaction fees and 100% money transfer to the designated charity across a range of financial systems.
Development of multiple pre-authorisation techniques.
Unique account and payment structuring.
Optimisation of algorithm efficiency when scaled up to large search sets within the final application.
Deliberate segregating of functionality including: the electronic transaction done at the server level (independent of the individual user devices) for immediate timely implementation; and the location tracking done at the user device level (independent of the central server) to maintain privacy requirements and keep certain information out of system 100.

### Conclusions and Interpretation

Throughout this specification, where used, the term “element” is intended to mean either a single unitary component or a collection of components that combine to perform a specific function or purpose.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Unless specifically stated otherwise, as apparent from the following discussions, it is appreciated that throughout the specification discussions utilizing terms such as “processing,” “computing,” “calculating,” “determining”, analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. A memory subsystem of a processing system includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the storage medium, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, unless otherwise specified, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while the Figures may only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein, unless otherwise specified.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (for example, a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage.

### INDUSTRIAL APPLICABILITY

The arrangements described are applicable to mobile tracking and event organization technologies.

The systems and methods herein, whilst being implemented on a computer in the form of computer software, is done so using very specific step by step techniques as described herein. These specific techniques are deliberate and unique in order to yield the levels of performance, convenience and functionality that the invention sets out to achieve. As such, the specific techniques cannot be seen a generic implementation as they are specific to embodiments of the present invention.

Changes and modifications in the specifically-described embodiments may be carried out without departing from the principles of the present invention, which is intended to be limited only by the scope of the appended claims as interpreted according to the principles of patent law including the doctrine of equivalents.

1. A system for selectively implementing an electronic transaction based on proximity detection of a user device, the electronic transaction including primary and secondary parameters, the system comprising:
a central server; and
a user device having a user I/O interface configured to receive one or more secondary parameters and being in communication with the central server, the user device including a location module for enabling selective location tracking of the user device by the central server;
wherein the primary and secondary parameters of the electronic transaction are transmitted to the central server and the central server conditionally pre-authorizes the electronic transaction such that if the primary parameters of the electronic transaction are not met, the electronic transaction is implemented based on the secondary parameters, wherein the primary parameters of the electronic transaction include the user device being within a predefined distance of a predefined location by a predefined time.

2. The system according to claim 1, wherein the electronic transaction includes a pecuniary transaction, wherein the secondary parameters are transmitted from the user device and include a pecuniary bid amount and a bid amount recipient, wherein the pecuniary transaction includes the bid amount being transferred to the bid amount recipient, and wherein the bid amount recipient is a nominated charitable organization.

3. (canceled)

4. (canceled)

5. The system according to claim 1, wherein the user I/O interface is configured to receive the primary parameters and transmit the primary parameters to the central server from the user device.

6. The system according to claim 1, wherein the conditional preauthorization of the electronic transaction is such that the electronic transaction is implemented substantially immediate at the predefined time.

7. The system according to claim 1, wherein the electronic transaction is implemented by the central server independently of the user device, and wherein the user device is a mobile smartphone.

8. (canceled)

9. The system according to claim 1, wherein the location module provides Global Positioning System (GPS) functionality, and wherein determining if the primary parameters are met includes tracking the location of the user device by way of GPS.

10. The system according to claim 9, wherein the location module provides short distance communications functionality, and wherein determining if the primary parameters are met includes the user device being recognized as being within a range for short distance communications.

11. The system according to claim 10, wherein the short distance communications functionality includes Bluetooth functionality, and wherein the predefined location is a location of another user device.

12. (canceled)

13. The system according to claim 1, wherein the central server includes a central database having a user sub-database for maintaining user data and an event sub-database for maintaining event data, wherein the primary and secondary parameters of the electronic transaction form at least a part of the event data or the user data, and wherein the user data includes a plurality of registered user profiles.

14. (canceled)

15. A system according to any one of the preceding claims wherein including a further user device such that the primary parameters are transmitted to the central server from the further user device.

16. A method for selectively implementing an electronic transaction based on proximity detection of a user device, the electronic transaction including primary and secondary parameters, the method comprising the steps of:
receiving by a user I/O interface of a user device, from a user of the user device, one or more secondary parameters;
transmitting to a central server the primary and secondary parameters of the electronic transaction, wherein the primary parameters of the electronic transaction includes the user device being within a predefined distance of a predefined location by a predefined time;
conditionally pre-authorizing, by the central server, the electronic transaction;
tracking by the central server the location of the user device by a location module of the user device; and
if the primary parameters are met, implementing, by the central server based on the secondary parameters, the electronic transaction.

17. The method according to claim 16, wherein the electronic transaction includes a pecuniary transaction, and wherein the step of transmitting to the central server the primary and secondary parameters of the electronic transaction includes transmitting to the central server, from the user device, the secondary parameters.

18. (canceled)

19. The method according to claim 16, wherein the secondary parameters include a pecuniary bid amount and a bid amount recipient, wherein the step of implementing the electronic transaction includes transferring the bid amount to the bid amount recipient, and wherein the bid amount recipient is a nominated charitable organization.

20. (canceled)

21. The method according to claim 16, wherein the user I/O interface is configured to receive the primary parameters and the step of transmitting to the central server the primary and secondary parameters of the electronic transaction includes transmitting to the central server, from the user device, the primary parameters.

22. The method according to claim 16, wherein the step of conditionally pre-authorizing the electronic transaction includes substantially immediately implementing the electronic transaction at the predefined time.

23. The method according to claim 16, wherein the conditional step of implementing the electronic transaction by the central server is carried out independently of the user device, and wherein the user device is a mobile smartphone.

24. (canceled)

25. The method according to claim 16, wherein the location module provides Global Positioning System (GPS) functionality, and wherein determining if the primary parameters are met includes tracking the location of the user device by way of GPS.

26. The method according to claim 25, wherein the location module provides short distance communications functionality and determining if the primary parameters are met includes the user device being recognized as being within a range for short distance communications, wherein the short distance communications functionality includes Bluetooth functionality, and wherein the predefined location is a location of another user device.

27. (canceled)

28. (canceled)

29. The method according to claim 16, wherein the central server includes a central database having a user sub-database for maintaining user data and an event sub-database for maintaining event data, wherein the primary and secondary parameters of the electronic transaction form at least a part of the event data or the user data.

30. The method according to claim 29, wherein the user data includes a plurality of registered user profiles, wherein the step of transmitting to the central server the primary and secondary parameters of the electronic transaction includes transmitting to the central server the primary parameters from another user device.

31-34. (canceled)
